(19) United States
(12) Patent Application Publication
(10) Pub. No.: US 2006/0093961 A1
(43) Pub. Date: May 4, 2006

(54) Method of verifying electron beam data

(76) Inventors: Sung-Hoon Jang, Yongin-si (KR); Byoung-Sup Ahn, Suwon-si (KR); Young-Hwa No, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/262,710

(22) Filed: Nov. 1, 2005

(30) Foreign Application Priority Data
Nov. 2, 2004 (KR) 2004-88510

(51) Int. Cl. G03C 5/00

(52) U.S. Cl. 430/296; 430/30; 430/942

(57) ABSTRACT

A method of verifying electron beam data used to produce a photomask comprises dividing design data for the photomask into a plurality of repetitive regions, sequentially converting the sequential regions into electron beam data, and determining whether electron beam data corresponding to a current repetitive region is substantially identical to electron beam data corresponding to a previous repetitive region.

### BACKGROUND OF THE INVENTION

1. Field of the Invention

The present invention relates generally to a method of verifying electron beam data used to form a photomask for a semiconductor manufacturing device. More particularly, the invention relates to a method of verifying the electron beam data by comparing electron beam data produced for one region of the photomask with electron beam data produced for another area region of the photomask.

This application claims the benefit of Korean Patent Application No. 2004-0088510, filed Nov. 2, 2004, the disclosure of which is hereby incorporated by reference in its entirety.

2. Description of the Related Art

Photolithography is a common process used in the manufacture of semiconductor devices such as computer processor chips, memory and the like. In general, photolithography is used to form conductive patterns in a semiconductor substrate. The conductive patterns are typically formed by creating a layer of resist on the semiconductor substrate and then exposing the resist to an exposure source (e.g., an electron beam) through a photomask so that portions of the photomask defining the patterns can be removed. In order to precisely form the patterns in the semiconductor substrate, a high degree of precision is required in the manufacture of the photomask itself. This is especially true in the manufacture of modern semiconductor devices having a very small design rule.

A photomask is generally manufactured from a design such as a drawing or another type of explicit or implicit representation of patterns to be formed in the semiconductor substrate. This representation is denoted in this written description by the term “design data”. The design data is generally produced by a design device comprising some form of computer aided design (CAD) software running on a computer system. The design data can be generated either by hand, or using an automated procedure, or a combination of the two.

In order to form the photomask from the design data, the design data must be converted into a format compatible with a photomask manufacturing device used to form the patterns on a blank photomask. In this written description, design data converted into a format compatible with a photomask manufacturing device is denoted as “electron beam data”.

In general, the conversion process between design data and electron beam data is required to decompose the patterns into smaller patterns that can be formed in the blank photomask. The smaller patterns typically comprise a set of polygons such as rectangles that can be formed by an electron beam in a photomask manufacturing device. In this written description, it will be assumed that the smaller patterns are all rectangles, but in general, this does not necessarily have to be the case.

Each of the smaller patterns (i.e., rectangles) is formed in the photomask by a “shot” or “shots” of an electron beam in the photomask manufacturing device. The manufacturing device's ability to accurately form each of the smaller patterns depends on of the size, shape, position, and arrangement of the smaller patterns. As a side note, the term “shot” is also used at times in this written description to refer to the smaller patterns themselves.

Unfortunately, the electron beam data produced by the conversion process may have some problems that could lead to defects in the photomask, and therefore defects in a semiconductor device formed with the photomask. For example, certain regions of the design data may be missing, distorted, or otherwise poorly formed in the electron beam data.

In order to detect problems in the electron beam data, a verification process is generally carried out on the electron beam data before it is input to the photomask manufacturing device. The verification process checks whether certain geometric design requirements are met by the electron beam data and then the conversion process is allowed to be repeated, at least in part, to correct any problems detected by the verification process.

Because the patterns represented by the design data and the electron beam data are generally extensive and intricate, and because the geometric design requirements for each of the smaller patterns are typically interdependent, a large amount of computation may be required to perform the verification process. For example, the verification process for a single set of electron beam data for one photomask may require the computational resources of an entire cluster of workstations over a sustained period of time.

In addition to the problems described above, existing methods of performing the conversion and verification processes may experience further problems where the size of the design data increases and an optical proximity effect correction is applied to the electron beam data.

FIG. 1 is a block diagram illustrating a conventional system for converting design data into electron beam data. Referring to FIG. 1, the system includes a design device 10, a data converting device 20, and a photomask manufacturing device 30.

Design device 10 produces design data using a CAD program, data converting device 20 includes a plurality of workstations, and converts the design data into electron beam data and verifies whether there any problems are apparent in the converted data, and photomask manufacturing device 30 manufactures the photomask using the electron beam data.

As described above, the design data produced by the design device 10 is large, i.e., its size may be several gigabytes. Accordingly, it takes a long time and requires significant system resources for data converting device 20 to convert the design data into the electron beam data. Also, errors with unidentified causes may appear in the electron beam data as the design data becomes larger and larger.

FIG. 2 is a flow chart illustrating a conventional method of verifying electron beam data. In this written description, method steps are denoted by parentheses (XXX) to distinguish them from exemplary system elements such as those shown in FIG. 1.

Referring to FIG. 2, design data is converted into electron beam data and the electron beam data is then stored (100). The electron beam data generated in step 100 is referred to hereafter as “first electron beam data”.

The design data is converted into electron beam data a second time using a similar method and the electron beam data is again stored (110). The electron beam data generated in step 110 is referred to hereafter as “second electron beam data”.

Next, the first and second electron beam data are compared to each other to determine whether they are identical (120). It is assumed that if the same electron beam data is produced by the conversion process twice, then the electron beam data is relatively error free. This assumption is generally effective, given the fact that the same errors in the conversion process typically don't occur twice in the same part of the electron beam data. One simple way to compare the first and second electron beam data is to perform an exclusive OR operation on the data. Where the first and second electron beam data are identical, the electron beam data is output to the photomask manufacturing device (140).

Where the above two electron beam data are not found to be identical to each other in step 120, distinct portions of the first and second electron beam data are visually inspected to determine which one of the electron beam data is correctly converted (130). The visual inspection can be made, for example, using commercial software such as machine vision software. After visually inspecting the distinct portions of the first and second electron beam data, the correctly converted electron beam data is output to photomask manufacturing device 30 (140).

FIG. 3 is a flowchart illustrating another conventional method of verifying electron beam data. Referring to FIG. 3, the design data is converted into electron beam data (200) using off the shelf commercial software. The electron beam data is then re-converted back into design data using an inverse conversion process (210), also implemented in off the shelf commercial software. The re-converted design data is then compared to the original design data to detect whether the two are identical (220). Where the original design data and the reconverted design data are identical, the electron beam data is output to the photomask manufacturing device (240). Otherwise, an error signal is generated (230), causing the conversion process to terminate.

As described with reference to FIG. 2, there is little possibility that the same error occurs repetitively. Similarly, in relation to FIG. 3, there is little possibility of the same error occurring in both the conversion process and the re-conversion process. Thus, it is possible to check abnormality of the converted electron beam data using the method described in relation to FIG. 3.

As described above, it takes long time and requires significant computing resources to convert the design data into the converted electron beam data. Unfortunately, the conventional methods described in relation to FIGS. 2 and 3 require the conversion to take place twice. Performing the conversion twice is inefficient.

### SUMMARY OF THE INVENTION

According to one embodiment of the present invention, a method of verifying electron beam data in a data converting device is provided. The method comprises dividing the design data into a plurality of repetitive regions, converting a first one of the repetitive regions into first electron beam data, converting a second one of the repetitive regions into second electron beam data, and determining whether the first electron beam data is substantially identical to the second electron beam data.

Preferably, determining whether the first electron beam data is substantially identical to the second electron beam data comprises either (1) comparing a number of shots in the first electron beam data with a number of shots in the second electron beam data; (2) comparing a total area of shots in the first electron beam data with a total area of shots in the second electron beam data; or (3) classifying shots in the first and second electron beam data into distinct classifications according to their sizes, and comparing a number of shots in each classification for the first and second electron beam data.

### BRIEF DESCRIPTION OF THE DRAWINGS

The invention is described below in relation to several embodiments illustrated in the accompanying drawings. Throughout the drawings like reference numbers indicate like exemplary elements, components, or steps. In the drawings:

FIG. 1 is a block diagram illustrating a conventional system for converting design data into electron beam data;

FIG. 2 is a flow chart illustrating a conventional method of verifying electron beam data;

FIG. 3 is a flow chart illustrating another conventional method of verifying electron beam data;

FIG. 4 is a diagram of electron beam data produced by converting design data according to an embodiment of the present invention;

FIG. 5 is a flowchart illustrating a method of verifying electron beam data according to an embodiment of the present invention;

FIG. 6 shows a comparison of two similar regions of electron beam data, wherein data for one of the regions was lost during a conversion process; and,

FIG. 7 shows a comparison of two similar regions of electron beam data, wherein data for one of the regions is abnormally divided.

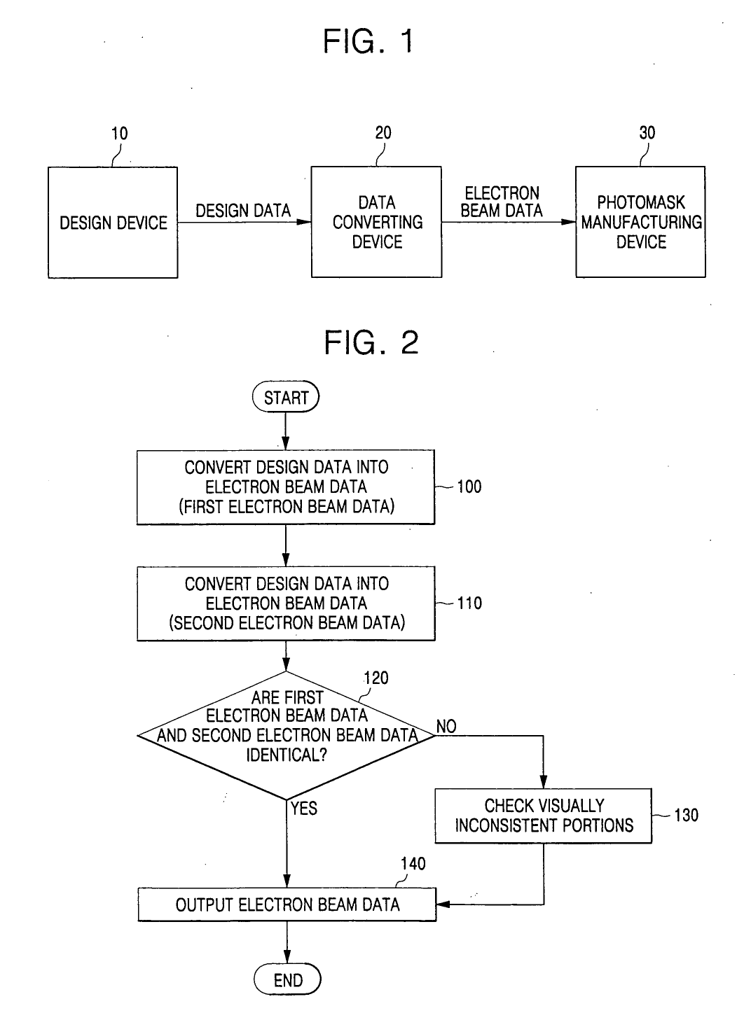

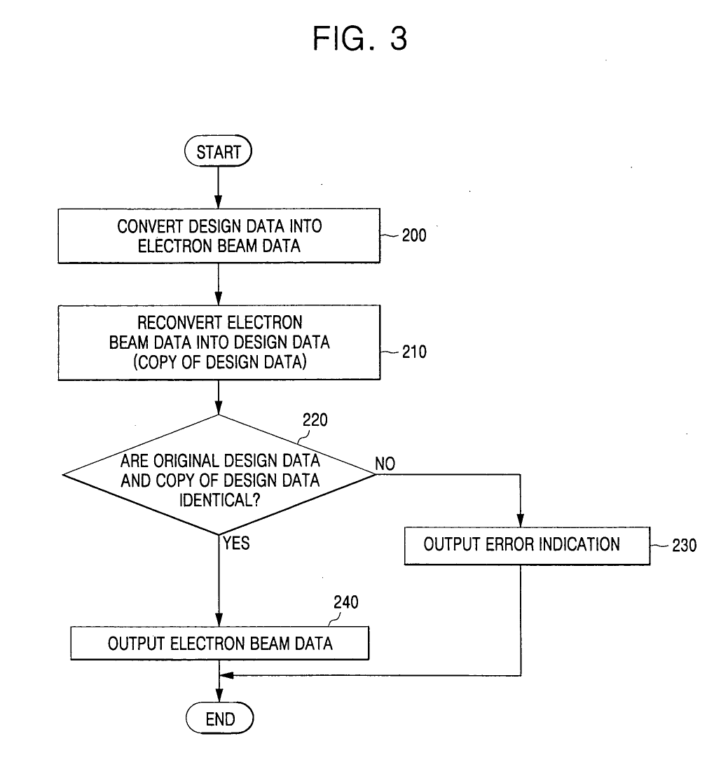

### DESCRIPTION OF THE EXEMPLARY EMBODIMENTS

Exemplary embodiments of the invention are described below with reference to the corresponding drawings. These embodiments are presented as teaching examples. The actual scope of the invention is defined by the claims that follow.

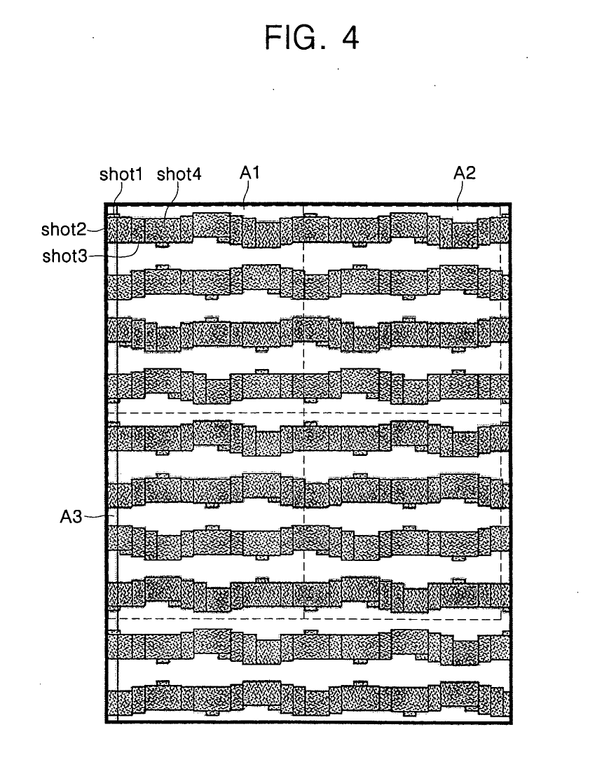

FIG. 4 is a diagram of electron beam data defining a pattern to be formed on a photomask. In FIG. 4, the electron beam data comprises a plurality of polygons (rectangles), each corresponding to a “shot” of an electron beam that will be applied to a blank photomask to form the pattern. The polygons are labeled in FIG. 4 as “shot1”, “shot2”, etc.

As seen in FIG. 4, the pattern comprises multiple repetitive regions, labeled A1 through A3 and delineated by broken lines. Repetitive regions frequently occur in electron beam data used to form photomasks for semiconductor devices characterized by repetitive elements. For example, a memory cell array of a semiconductor memory device typically comprises a plurality of memory cells arranged in a repetitive pattern.

Regions A1 through A3 are said to be repetitive because they contain the same number, shape, and size of shots. In addition, the overall size of each region is the same.

According to an embodiment of the present invention, design data representing repetitive regions of a device is divided into repetitive portions. The repetitive portions of the design data are then sequentially converted into electron beam data and resulting successive chunks of electron beam data are compared to each other to check whether or not they are identical. In other words, a portion of the design data may be converted to produce region A1 of the electron beam data, then a successive portion of the design data may be converted to produce region A2, and so forth. Regions A1 and A2 are then compared to each other to verify whether they are identical. It is assumed that where regions A1 and A2 are identical, no errors exist in electron beam data at these regions.

Specific information used to determine whether successive chunks of electron beam data are identical include, for example, the number of polygons in each region, the overall size of patterns in the regions, the size of the polygons, and so forth.

In the method described above, the conversion and verification are carried out at the same time. In addition, the conversion takes place only once, thereby limiting the amount of time it takes to produce verified electron beam data.

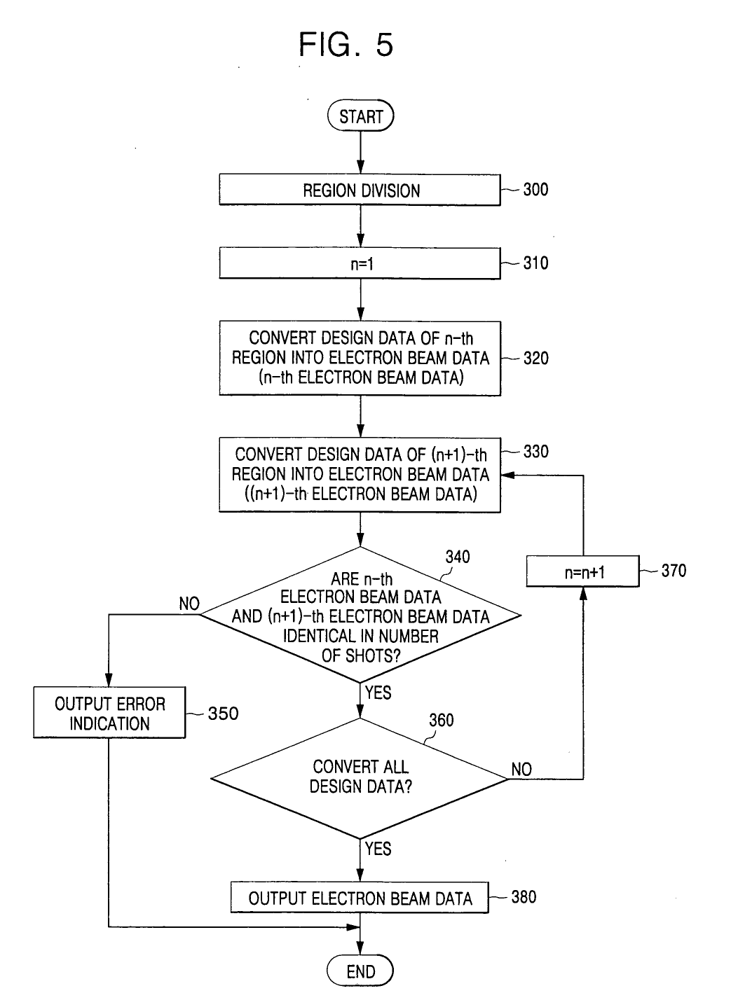

FIG. 5 is a flowchart illustrating a method of verifying electron beam data according to an embodiment of the present invention. The method is generally carried out in a system comprising a design device generating design data, a data converting device receiving the design data and converting the design data into electron beam data, and a photomask manufacturing device receiving the electron beam data and using the electron beam data to produce a photomask. Referring to FIG. 5, the method comprises dividing design data into a plurality of substantially equal-sized regions (300) containing the same pattern. The regions are labeled with numbers ranging from 1 to “N”.

A variable “n” representing a number of a region of the design data to be converted into electron beam data is initialized to “1” (310). Then, the n-th region of the design data is converted into electron beam data (320). The electron beam data resulting from the conversion of the n-th region of the design data is denoted in this description as “n-th electron beam data”.

After the n-th region of the design data is converted into electron beam data, the (n+1)-th region of the design data is converted into electron beam data (330). The electron beam data resulting from the conversion of the (n+1)-th region of the design data is denoted in this description as “(n+1)-th electron beam data”.

Next, the number of polygons (denoted “shots” in the drawings) in the n-th electron beam data is compared to the number of polygons in the (n+1)-th electron beam data (340). Where the number of polygons in the n-th and (n+1)-th electron beam data are different, a signal indicating an error is output from the data converting device and the data converting process is terminated (350). However, where the number of polygons in the n-th and (n+1)-th electron beam are the same, the data converting device determines whether all of the design data has been converted into electron beam data (360). Where all of the design data has been converted into electron beam data, the electron beam data is output to the photomask manufacturing device (380). Otherwise, the value of “n” is incremented (370), and steps 330 and 340 are repeated.

Referring to FIG. 5, the comparison between the number of polygons in the n-th and (n+1)-th electron beam data is performed in a step 340. Step 340 could be replaced or supplemented, however, by another step wherein the total cumulative size (i.e., area) of the polygons in the n-th and (n+1)-th regions is compared. A difference in the total cumulative size of the polygons could also be used to determine whether one of the design data regions was abnormally converted.

In other words, step 340 can be replaced by various alternative ways of determining whether the n-th and (n+1)-th electron beam data are identical. One such alternative way to determine whether the n-th and (n+1)-th electron beam data are identical is to classify the polygons in these data into distinct classifications and then compare the total number of polygons within each classification in the respective groups.

Because many semiconductor devices contain large repetitive regions, this method may be very useful in reducing the time and other resources required to inspect the electron beam data.

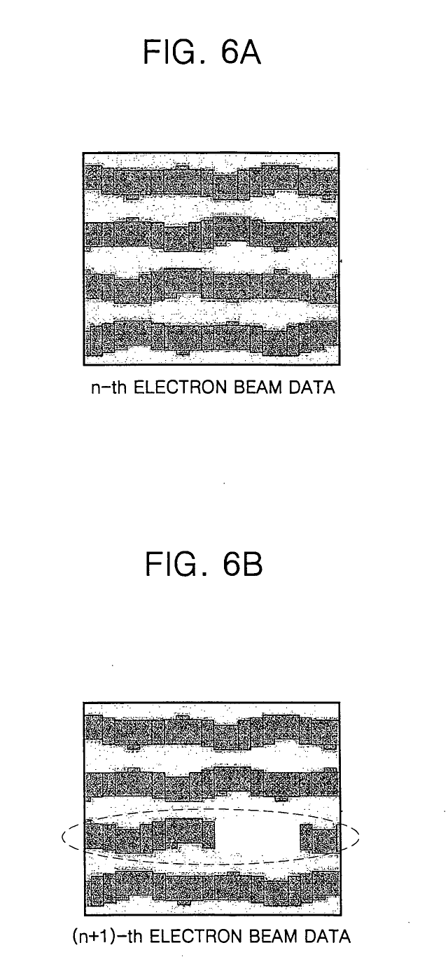

FIG. 6 is an illustration showing two sets of electron beam data, wherein one of the two sets of electron beam data has a missing part relative to the other set of electron beam data. The missing part was lost in the conversion process used to generate the electron beam data.

Referring to FIG. 6, the number of polygons (or “shots”) in the electron beam data of FIG. 6B is clearly smaller than the number of polygons in FIG. 6A. Accordingly, the fact that the electron beam data in FIGS. 6A and 6B are not identical can be readily detected by comparing the number of polygons in each of them. Similarly, since the total size (i.e., area) of the polygons in FIG. 6B is clearly smaller than the total area of the polygons in FIG. 6B, the total size of the polygons can also be used to detect whether the electron beam data in FIGS. 6A and 6B is identical. Likewise, the number of polygons of each size in a set of size classifications could also be used to distinguish the electron beam data in FIG. 6A from the electron beam data in FIG. 6B. For example, FIG. 6B clearly has less “big” polygons than FIG. 6A because at least two relatively large rectangles are missing in FIG. 6B relative to FIG. 6A.

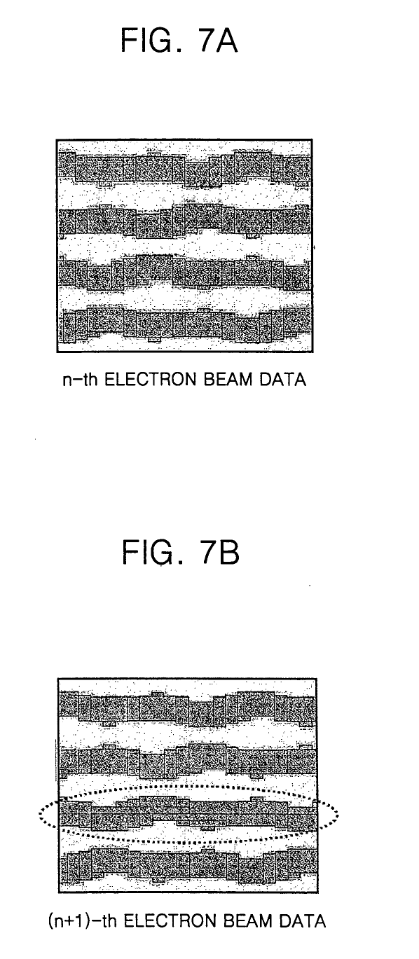

FIG. 7 is an illustration showing two sets of electron beam data, wherein one of the two sets contains polygons that were abnormally divided. In particular, FIG. 7B shows a set of polygons (denoted by a broken oval) that were divided into an excessive number of polygons.

By comparing the total number of polygons in the electron beam data of FIGS. 7A and 7B, it is becomes readily apparent that these two sets of electron beam data are not identical.

Similarly, the distinctness of the sets of electron beam data in FIGS. 7A and 7B could also be detected by comparing the number of polygons in different size classifications in each set. Clearly, the number of relatively larger polygons in FIG. 7B is smaller than the number of relatively larger polygons in FIG. 7A.

As described above, conventional methods of converting design data into electron beam require at least two conversions to take place: either two conversions of the design data into electron beam data, or a conversion of the design data into electron beam data and a subsequent re-conversion of the electron beam data back into design data. As demonstrated by embodiments of the present invention, however, the data conversion can be performed with only one conversion process, thereby saving significant time and computational resources.

Embodiments of the invention find ready application especially in the manufacture of semiconductor devices having highly repetitive patterns, such semiconductor memory devices.

The foregoing preferred embodiments are teaching examples. Those of ordinary skill in the art will understand that various changes in form and details may be made to the exemplary embodiments without departing from the scope of the present invention which is defined by the following claims.

What is claimed:

1. A method of converting design data into electron beam data for a photomask manufacturing device, the method comprising:
dividing the design data into a plurality of repetitive regions;
converting a first one of the repetitive regions into first electron beam data;
converting a second one of the repetitive regions into second electron beam data; and,
determining whether the first electron beam data is substantially identical to the second electron beam data.

2. The method of claim 1, wherein determining whether the first electron beam data is substantially identical to the second electron beam data comprises:
comparing a number of shots in the first electron beam data with a number of shots in the second electron beam data.

3. The method of claim 1, wherein determining whether the first electron beam data is substantially identical to the second electron beam data comprises:
comparing a total area of shots in the first electron beam data with a total area of shots in the second electron beam data.

4. The method of claim 1, wherein determining whether the first electron beam data is substantially identical to the second electron beam data comprises:
classifying shots in the first and second electron beam data into distinct classifications according to their sizes; and,
comparing a number of shots in each classification for the first and second electron beam data.

5. The method of claim 1, further comprising:
(a) converting an n-th region of the repetitive regions into n-th electron beam data;
(b) converting an (n+1)-th region of the repetitive regions into (n+1)-th electron beam data;
(c) determining whether the n-th electron beam is substantially identical to the (n+1)-th electron beam data;
(d) incrementing n; and,
(e) repeating (b) and (c).

6. The method of claim 5, wherein determining whether the n-th electron beam data is substantially identical to the (n+1)-th electron beam data comprises:
comparing a number of shots in the n-th electron beam data with a number of shots in the (n+1)-th electron beam data.

7. The method of claim 5, wherein determining whether the n-th electron beam data is substantially identical to the (n+1)-th electron beam data comprises:
comparing a total area of shots in the n-th electron beam data with a total area of shots in the (n+1)-th electron beam data.

8. The method of claim 5, wherein determining whether the n-th electron beam data is substantially identical to the (n+1)-th electron beam data comprises:
classifying shots in the n-th and (n+1)-th electron beam data into distinct classifications according to their sizes; and,
comparing a number of shots in each classification for the n-th and (n+1)-th electron beam data.
